(19) United States
(12) Patent Application Publication
(10) Pub. No.: US 2010/0043460 A1
(43) Pub. Date: Feb. 25, 2010

(54) CHILLER AND REACTION BLOCKS

(75) Inventor: Ivan Van de Vyver, Rochford (GB)

Correspondence Address: WOOD, HERRON & EVANS, LLP, 2700 CAREW TOWER, 441 VINE STREET, CINCINNATI, OH, 45202, US

(73) Assignee: Electrothermal Engineering Limited, Southend-on-Sea (GB)

(21) Appl. No.: 12/194,300

(22) Filed: Aug. 19, 2008

(51) Int. Cl. F24F 3/16; G05D 23/00; G05D 16/00; F26B 3/30

(52) U.S. Cl. 62/78; 700/300; 392/407; 422/188; 422/105

(57) ABSTRACT

A reaction block is provided that utilizes a refrigerant gas for cooling that includes a plurality of reaction stations each defining a reaction chamber for receiving a reaction vessel and defining a gas conducting passageway for conducting the refrigerant gas through the reaction station in temperature transmitting relation thereto. The reaction block also includes a metering means in fluid communication with a respective one of the reaction stations and is configured to receive a liquid refrigerant and to deliver an amount of refrigerant gas to the gas conducting passageway of one of the reaction stations in order to cool the contents inside the reaction vessel located at that reaction station. The metering means is also configured so that the amount of the refrigerant gas delivered to the gas conducting passageway of one reaction station is independent of the amount of refrigerant gas delivered to another one of the reaction stations.

### FIELD OF THE INVENTION

The disclosure relates generally to a multi-station reaction apparatus, and more particularly to a multi-station reaction apparatus with a gas chiller.

### BACKGROUND OF THE INVENTION

Reaction blocks are used to facilitate a chemical reaction. Each general location in the reaction block where a reaction vessel such as test tubes or other glass labware is located is a reaction station or cell. Typically, reactants are placed inside the reaction vessel and placed within an interior chamber provided in the reaction block. Then, the thermal environment of the chamber is monitored and adjusted to facilitate a desired reaction.

To provide the necessary thermal environment required to carried out the particular reaction, the reaction station is provided with a means for heating or cooling its inner chamber. There are varying ways to heat and cool the reaction station. The reaction station may be heated by an electrical heating device, and may be cooled by a refrigeration system or chiller coupled to the reaction block.

In reaction blocks with multiple reaction stations, the individual control and maintenance of a thermal environment of one reaction station separate from another reaction station permits a reaction at any station to be carried out at any temperature within the range handled by the reaction block, without disturbing the thermal environment of a neighboring reaction.

### SUMMARY OF THE INVENTION

At least one embodiment of the disclosure is a reaction assembly configured to control a temperature of contents contained within a reaction vessel utilizing a refrigerant gas comprising: a plurality of reaction stations each defining a reaction chamber adapted to receive an associated reaction vessel and defining a gas conducting passageway for conducting the refrigerant gas through the reaction stations in temperature transmitting relation thereto; a heating device thermally coupled to a respective one of the plurality of reaction stations and configured to heat the contents inside the reaction vessel at the respective one of the plurality of reaction stations such that the heating of the one respective reaction station is thermally independent from the heating of another one of the plurality of reaction stations; and a metering device in fluid communication with the respective one of the reaction stations and configured to receive liquid refrigerant and to deliver an amount of refrigerant gas to the gas conducting passageway of the one respective reaction station to cool the contents inside the associated reaction vessel such that the amount of the refrigerant gas delivered to the gas conducting passageway of the one reaction station is independent of the amount of refrigerant gas delivered to the another one of the reaction stations.

Other embodiments provide a method for cooling contents contained inside a reaction vessel arranged at a respective reaction station within a reaction block comprising: introducing a refrigerant gas into a respective reaction station of a reaction block; conducting the refrigerant gas through a gas conducting passageway defined within the respective reaction station in temperature transmitting relation thereto; and cooling contents inside a reaction vessel contained at the respective reaction station within the reaction block with the refrigerant gas.

Still other embodiments provide a reaction block configured to utilize a refrigerant gas comprising: a plurality of reaction stations each defining a reaction chamber adapted to receive an associated reaction vessel and defining a gas conducting passageway for conducting the refrigerant gas through the reaction stations in temperature transmitting relation thereto; and a metering means in fluid communication with a respective one of the reaction stations and configured to receive a liquid refrigerant and to deliver an amount of refrigerant gas to the gas conducting passageway of the one reaction station to cool the contents inside the associated reaction vessel such that the amount of the refrigerant gas delivered to the gas conducting passageway of the one reaction station is independent of the amount of refrigerant gas delivered to another one of the reaction stations.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present disclosure. It is important, therefore, that the claims be regarded as including such equivalent constructions insofar as they do not depart from the spirit and scope of the present invention.

### BRIEF DESCRIPTION OF THE DRAWINGS

FIG. 1 is a right side perspective view of an example embodiment of a reaction assembly including a reaction block coupled to a chiller.

FIG. 2 is a right side perspective view of an example embodiment of a reaction block with a portion of the chassis broken away to illustrate components inside the reaction block.

FIG. 3 is a right side perspective view of the reaction block shown in FIG. 2 with a portion of the chassis cut away and a cross-sectional view through two reaction cells.

FIG. 4 is a cross-sectional view of an example embodiment of a reaction cell showing a helical gas groove and pipe connections.

FIG. 5 is a cut away view of another example embodiment of a reaction cell showing a spirally wound heater cartridge and a spirally wound metal tube cast into a reaction block.

FIG. 6 is a cut away view of a portion of an example embodiment of a reaction cell showing a cross-sectional view of the reaction cell and an example electromagnetic stirrer assembly.

FIG. 7 is a cross-sectional view of another example embodiment of a reaction cell showing another example electromagnetic stirrer assembly.

FIG. 8 is flow diagram of an example embodiment of a single stage refrigeration system connected to a portion of an example embodiment of reaction block and showing electrical connections.

FIG. 9 is an enlarged view of a portion of FIG. 8.

FIG. 10 shows an example embodiment of a portion of a two-stage refrigeration circuit.

FIG. 11 shows an example schematic of a controller coupled with a memory and an I/O port.

### DETAILED DESCRIPTION

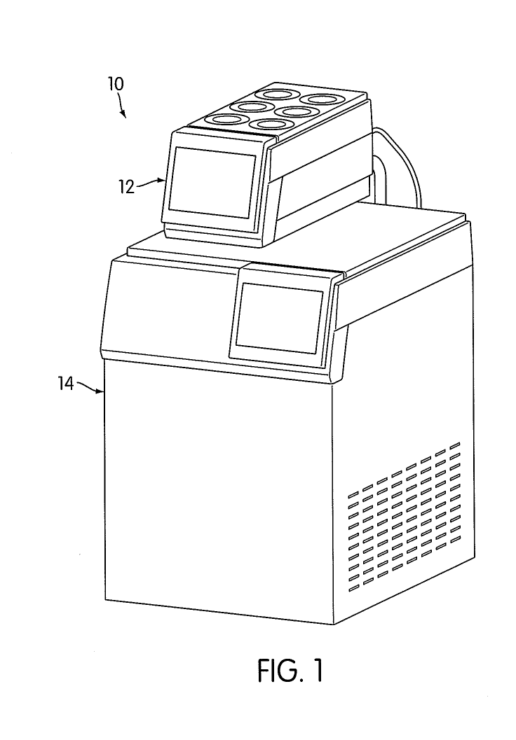

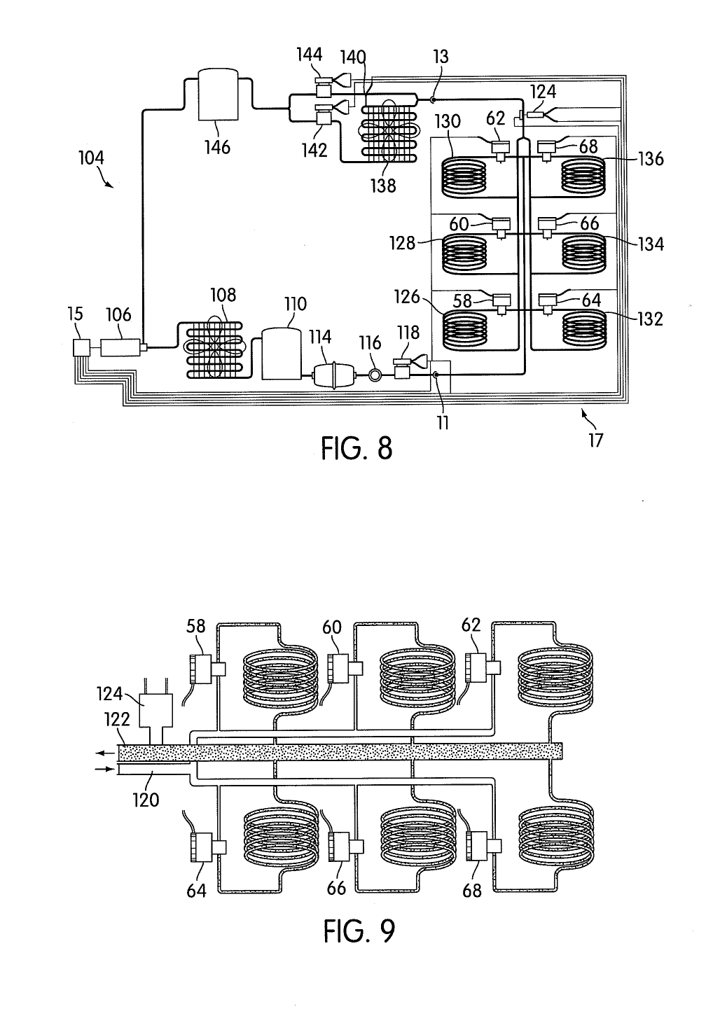

Some preferred embodiments will now be described with reference to the drawing figures, in which like reference numbers refer to like parts throughout. FIG. 1 shows a vapor-compression type reaction assembly 10 with a reduced footprint that is configured to cool contents inside a reaction vessel utilizing a refrigerant gas. The reaction assembly 10 includes a reaction block 12 and a refrigeration system or a chiller unit 14. The chiller 14 components are mounted on a box section chassis inside a case and are arranged to achieve the minimum overall size or footprint. The reaction block 12 interconnects to the gas chiller 14 by way of two insulated flexible gas pipes with detachable self sealing, gas tight quick fit connectors 11, 13, and a communication cable 17 (FIG. 8). There is no capillary tube. The overall assembly 10 is configured such that when switching from a cooling process to a heating process, the chiller 14 remains coupled to the reaction block 12. Since the block being cooled is directly attached to the chiller with an evaporator as a jacket of the heater block, the chiller does not require disconnection. Most reaction blocks require an intermediate liquid coolant. These other blocks require that the chiller be disconnected from the reaction block and drained prior to the beginning of a heating process because of the different refrigerant being used for each of the cooling and the heating processes.

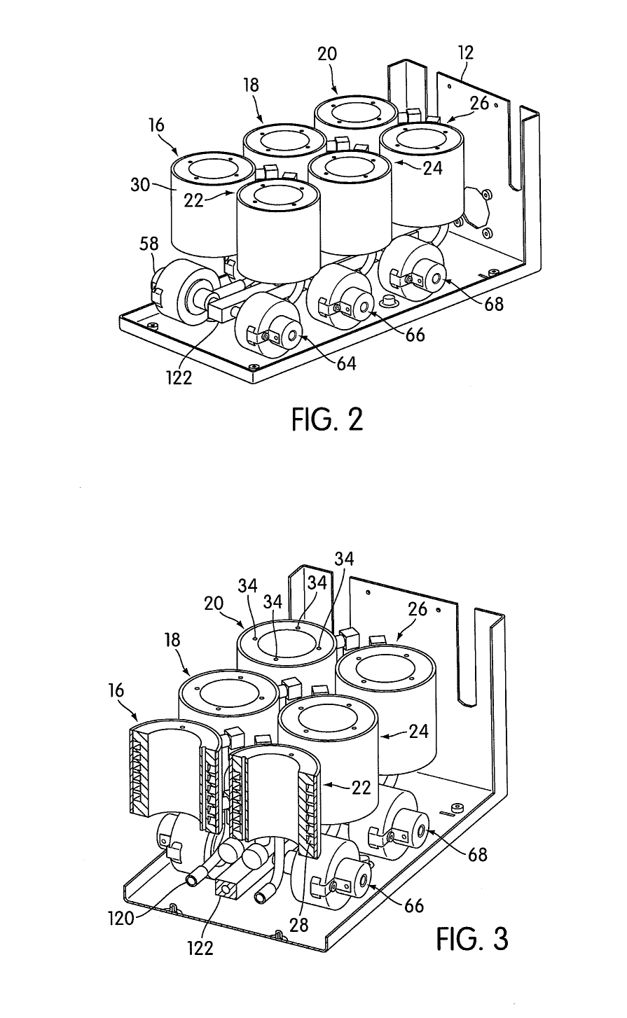

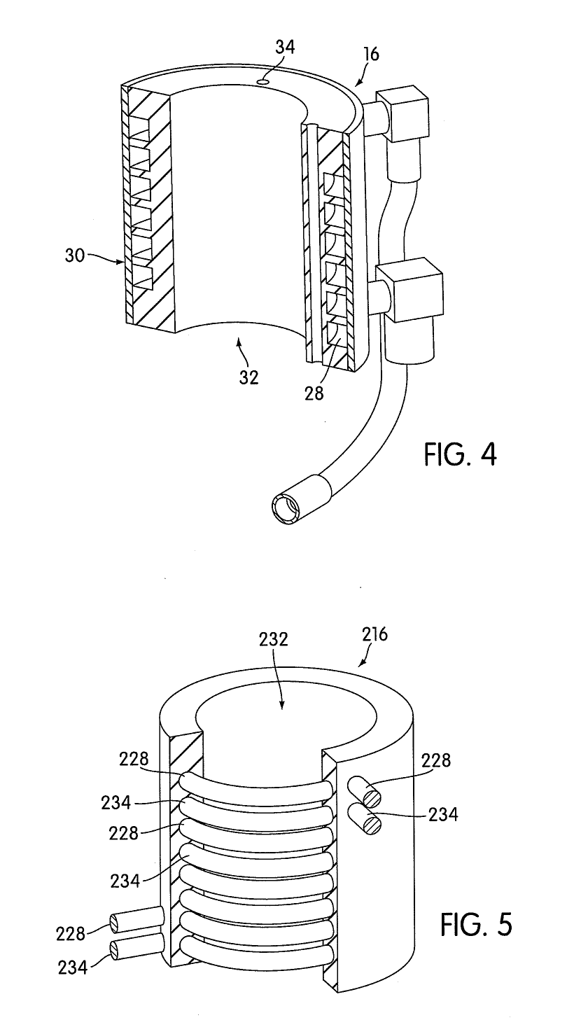

Referring to FIG. 2, a controller 15 is coupled to the reaction block 12. The controller 15 may be electronic and include a microprocessor on a circuit board for controlling electromechanical solenoid valves 118, 142 and 144 (shown in FIG. 8). Optionally, the controller 15 may include a memory unit to store software and data, and the microprocessor may be coupled to the memory unit for executing the software stored in the memory unit. The electronic controller 15 receives data signals from the pressure sensors and temperature sensors and controls switches on a control panel such as those configured to receive selected temperature settings.

Referring to FIG. 11, the controller 15 can include a processor 202 for executing the instructions on the software stored on the non-volatile memory 208 using the system memory 206. The processor 202 can communicate with external devices through the input-output port (I/O) 210 connected to the processor 202 through a bus 212.

The memories 206 and 208 are computer readable media. The computer-readable media includes all possible kinds of media in which computer-readable data is stored or included or can include any type of data that can be read by a computer or a processing unit. The computer-readable media include for example and not limited to storing media, such as magnetic storing media (e.g., ROMs, floppy disks, hard disk, and the like), optical reading media (e.g., CD-ROMs (compact disc-read-only memory), DVDs (digital versatile discs), re-writable versions of the optical discs, and the like), hybrid magnetic optical disks, organic disks, system memory (read-only memory, random access memory), non-volatile memory such as flash memory or any other volatile or non-volatile memory, other semiconductor media, electronic media, electromagnetic media, infrared, and other communication media such as carrier waves (e.g., transmission via the Internet or another computer). Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer-readable media can store and execute computer-readable codes that are distributed in computers connected via a network. The computer readable medium also includes cooperating or interconnected computer readable media that are in the processing system or are distributed among multiple processing systems that may be local or remote to the processing system. The present invention can include the computer-readable medium having stored thereon a data structure including a plurality of fields containing data representing the techniques of the present invention.

An example of a computer, but not limited to this example of the computer, that can read computer readable media that includes computer-executable instructions of the present invention includes a processor that controls the computer. The processor uses the system memory and a computer readable memory device that includes certain computer readable recording media. A system bus connects the processor to a network interface, modem or other interface that accommodates a connection to another computer or network such as the Internet. The system bus may also include an input and output interface that accommodates connection to a variety of other devices.

The reaction block 12 may include a plurality of reaction stations 16, 18, 20, 22, 24, 26 as shown in FIG. 2. The reaction stations 16, 18, 20, 22, 24, 26 may be formed in block formed of aluminum or other metal or other suitable material having thermal transmitting qualities. The reaction block 12 may be formed as a modular system, wherein each of the reaction stations 16, 18, 20, 22, 24, 26 is formed as a separate module or the block may be formed as a single block. The reaction block 12 may be coated with a polytetrafluoroethylene (“PTFE”) or other non-stick coating, although this is optional.

In the reaction block 12, the reaction stations are configured as two parallel banks of three reaction stations. The number of reaction stations the reaction block has is not limited to six. There may be fewer stations or more stations, such as four, ten or fifty. Each reaction station 16, 18, 20, 22, 24, 26 defines a reaction chamber 32 adapted to receive and store a reaction vessel (not shown).

Each reaction station 16, 18, 20, 22, 24, 26 has a gas conducting passageway 28 (FIG. 3) for moving the cooling refrigerant gas around the reaction station in temperature transmitting relation thereto. The gas conducting passageway 28 is defined within walls of the reaction stations 16, 18, 20, 22, 24, 26 and makes possible direct contact between the refrigerant gas and the reaction block. By cutting a channel directly into the reaction block 12 to form the gas conducting passageway 28, a temperature differential that might otherwise exist if a metal tube were embedded in the block, is removed. Providing the cooling refrigerant in direct contact with the block maximizes the rate of cooling of the block, and allows for a lower final operating temperature to be obtained.

The gas conducting passageway 28 may be a machined groove, such as a helical groove, cut into the metal block of the reaction stations 16, 18, 20, 22, 24, 26 and sealed with a sleeve 30, such as a metal sleeve that is an aluminum sleeve or a copper sleeve. Alternatively, the gas conducting passageway 28 may be sealed with a metal plate, depending on the shape of block. The gas conducting passageway 28 is located toward and around the bottom portion of the reaction stations 16, 18, 20, 22, 24, 26 for efficient cooling of the reactants inside the reaction vessels that may be stored in the reaction stations 16, 18, 20, 22, 24, 26.

Alternatively, the gas conducting passageway 28 may be fitted with a metal tube 228 formed of steel or other suitable material with thermal transmitting qualities, as shown in FIG. 5. To compensate for a thermal barrier that may be created by air gaps formed between the tube 228 and the passageway 28, the metal tube 228 may be cast into the reaction cell 226. Casting the tube into the aluminum block 226 allows intimate contact between the aluminum block 226 and the metal tube 228 without the air gaps. Thus, by directly casting the metal tube 228 into the walls of the reaction cell 226, a very good thermal junction between the metal tube 228 and the block 226 is attained with approximately no thermal loss. Also, fitting a metal tube allows feed tube connectors to be welded or brazed to the metal tube 228, guaranteeing a sealable gas passageway. To achieve this construction, the metal tube 228 is first formed around a mandrill. The metal tube 228 is then placed into the reaction block casting mold prior to molten aluminum being pored over it. When cool, the metal tube 228 is removed from the casting mold. The final process is to machine the reaction block bore to form the cell chamber 232 and finishing dimensions.

In the embodiment where the reaction block 12 is configured a single block 12, the reaction stations are cooled as a commonly controlled chamber, as opposed to independently controlled chambers. In this case, the reaction block 12 may be configured with a single gas conducting passageway 28 for the entire block that would operate to cool the block 12 as a unit.

Provided downstream of the gas conducting passageway 28 may be an optionally provided stop valve or gas stop connected in communication with the controller 15. The valve may be, for example, a solenoid actuated valve operable to shut off the gas conducting passageway 28 from receiving and transmitting refrigerant gas. The controller 15 may act to actuate the gas stop close when, for example, the cell is heated above a certain temperature, such as above ambient temperature, for example. The controller 15 may act to actuate the gas stop open and to restore gas flow to the cell when cooling is required, provided that the cell temperature is not above a predetermined temperature, such as 100° C., for example. In the example embodiment shown, when the cell temperature is above the predetermined temperature, in this case 100° C., the cell will be allowed to cool naturally to 100° C. before the gas flow is restored. The cell temperature should naturally tend to drop rapidly from a high cell temperature to about 100° C. without the assistance of cooling gas.

Located around a top portion of each of the reaction stations is an optional reflux cooling means (not shown) to chill the top portion of the reaction stations and condense reactant vapors back into the reaction vessels. The reflux unit may be an accessory to the chiller unit 14 and uses known technology. The reflux cooling, for example, may be a thermoelectric cooler or Peltier device. The Peltier device may be arranged such that one face of the Peltier device is thermally coupled to both the reaction station 16, 18, 20, 22, 24, 26 and the reaction vessel, and such that the opposite face is thermally coupled to a heat sink. The heat sink may be cooled by cold water flowing through adjacent rails. The cooling action of a respective Peltier device is individually controlled by means of an electronic current applied to it and regulated by the controller 15. The reflux cooling means may in other embodiments be provided by a hollow cylinder or a tubular coil 46 through which cooled refrigerant flows or there may be a combination of moving cooling refrigerant gas moving around the hollow cylinder or tubular coil.

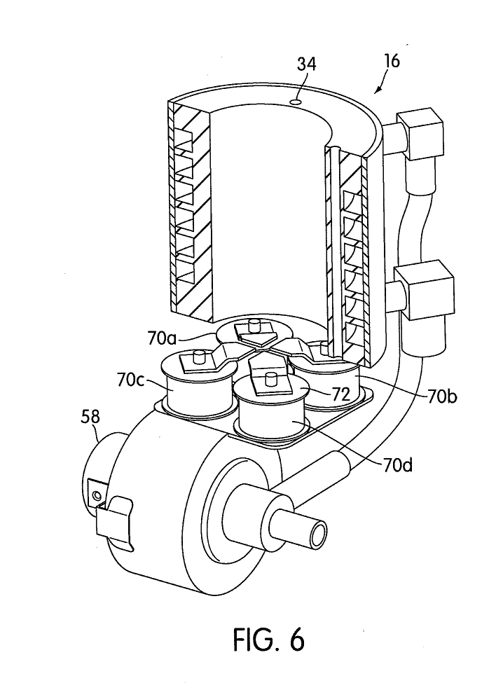

To control the delivery of the refrigerant gas to the reaction stations 16, 18, 20, 22, 24, 26 each of the reaction stations 16, 18, 20, 22, 24, 26 has its own electronic metering device 58, 60, 62, 64, 66 and 68 (FIGS. 5 and 6). The metering devices 58, 60, 62, 64, 66 and 68 are arranged in fluid communication with a respective reaction station 16, 18, 20, 22, 24, 26. The metering devices 58, 60, 62, 64, 66 and 68 are configured to receive liquid refrigerant and to deliver an amount of refrigerant gas to the gas conducting passageway 28 of the associated reaction station in an amount sufficient to cool the contents inside the associated reaction vessel to a desired temperature.

The metering devices 58, 60, 62, 64, 66 and 68 may be thermal expansion valves configured to expand the liquid refrigerant to gaseous refrigerant, so that refrigerant is feed directly into the reaction cell to maximize a rate of cooling and the final temperature. The chambers of the reaction stations 16, 18, 20, 22, 24, 26 are cooled directly by expanded refrigerant from the chiller 14 and not by an intermediate fluid or a capillary tube. Providing each reaction station 16, 18, 20, 22, 24, 26 with a separate metering device 58, 60, 62, 64, 66 and 68 enables the temperature of the chambers to be independently controlled. Specifically, the metering devices 58, 60, 62, 64, 66 and 68 are configured such that the amount of refrigerant gas delivered to the gas conducting passageway 28 of one of the reaction stations 16, 18, 20, 22, 24, 26 is independent of the amount of refrigerant gas delivered to another one of the reaction stations 16, 18, 20, 22, 24, 26. Thereby, each of reaction stations 16, 18, 20, 22, 24, 26 are provided with independent cooling. In an alternative embodiment, the reaction stations 16, 18, 20, 22, 24, 26 are constructed and arranged as a group of cells with commonly controlled chambers that adjust together to a given temperature. The commonly controlled chambers may be operated with block control using a single metering valve, for example.

A heating device or means may be thermally coupled to the reaction stations 16, 18, 20, 22, 24, 26 and configured to heat the contents inside the reaction vessels at each of the reaction stations 16, 18, 20, 22, 24, 26 up to around +300° C. (Celsius), for example. The heating device 34 is arranged such that the heating of one of the reaction stations 16, 18, 20, 22, 24, 26 is thermally independent from the heating of a neighboring reaction station 16, 18, 20, 22, 24, 26. As shown in FIG. 3, the heating device may be a cartridge heater 34 inserted vertically in four positions within the wall of the reaction cell. The cartridge heater 34 may be a dc (direct current) powered electrical cartridge heater provided within wall of the reaction station, and may be configured to be individually controlled by the electronic controller 15, for example through wires connected to the controller 15. Alternatively, the cartridge heater 156 can be wirelessly controlled by the controller 15 using protocols such as BLUETOOTH, IEEE 802.11, etc.

In an alternative embodiment shown in FIG. 5, a cartridge heater 234 is shown cast into an aluminum block of the reaction cell and spirally wound within the reaction cell walls. Casting the heater into the aluminum block provides very good contact and eliminates air gaps and thermal losses. In still other embodiments, the heating device may be, for example, an infra-red heater, a mineral heater, a sleeve heater surrounding the reaction vessel or a heater element located adjacent to the reaction vessel or any other suitable means for heating the interior chamber of the reaction cell.

In order to maintain and adjust a temperature at each reaction station 16, 18, 20, 22, 24, 26, a temperature sensor or transducer is provided. The temperature sensor is provided in communication with the controller 15 and is configured to provide temperature sensing information or feedback to the controller 15. As the temperature of the reaction chamber departs from an established temperature, the controller 15 acts to adjust the temperature to the desired temperature setting. The action of the controller 15 to adjust the temperature may be triggered by a temperature departure from a predetermined temperature range of acceptable temperatures or from a change from a specific temperature.

If the temperature departure sensed is an elevation in temperature, the controller 15 acts to open the metering valve(s) 58, 60, 62, 64, 66 and 68 to decrease the temperature of or cool the respective reaction station 16, 18, 20, 22, 24, 26. If the temperature departure sensed is a decrease in temperature, the controller 15 acts to activate the heating device to raise the temperature of or heat the respective reaction station 16, 18, 20, 22, 24, 26. Each temperature sensor may be connected to an optional overall temperature monitoring system configured to simultaneously monitor each of the temperature sensors or to the controller 15.

The temperature sensor 70 can be any type of device that will sense a temperature status and provide information for use by the controller 15. The temperature sensor may, for example, be an electronic thermometer arranged in the reaction vessel of a particular reaction station 16, 18, 20, 22, 24, 26 and configured to sense the cooling or heating temperature, or there may be separate temperature sensors provided, one for sensing a heating temperature and one for sensing a cooling temperature. For example, the temperature sensor for monitoring the cooling system may be a platinum resistance sensor, or a thermistor (for example, 140 in FIG. 8) in a small diameter, corrosion-resistant tube placed inside the reaction vessel and fixed to a cap of the respective reaction vessel or the temperature sensor for the heating system may be a thermocouple associated with each reaction station 16, 18, 20, 22, 24, 26. The cap is configured to seal a respective reaction vessel and is formed of plastic, metal or any other suitable material for sealing the reaction vessels.

Each reaction station 16, 18, 20, 22, 24, 26 may also be provided with an optional stirring device 74 for stirring the contents inside a respective reaction vessel. The stirring device 74 is selected from a material that is capable of stirring the reactants in both cold and hot temperatures. The stirring device 74 can be a magnetic stirrer which is coated with a non-stick coating such as a PTFE or a glass-coated rod magnet or formed of any other suitable material. The stirrer 74 is configured to stir the reactants either by itself or by means of an attached vane or other device capable of stirring the contents inside the reaction vessel. The movement of the stirring device 74 is generated by magnetic coupling of the stirring device 74 to a magnetic field generated by a drive system 76 disposed at a respective reaction station 16, 18, 20, 22, 24, 26 beneath a respective reaction vessel, respectively. The drive system 76 can be a magnetic clutch system including an electric motor 78 or other suitable driver means that is configured to be in communication with the controller 15. The motor 78 is arranged at the reaction station 16, 18, 20, 22, 24, 26 in such a manner that it is thermally protected from temperature extremes such as extreme cold or extreme heat which would interfere with the operation of the motor.

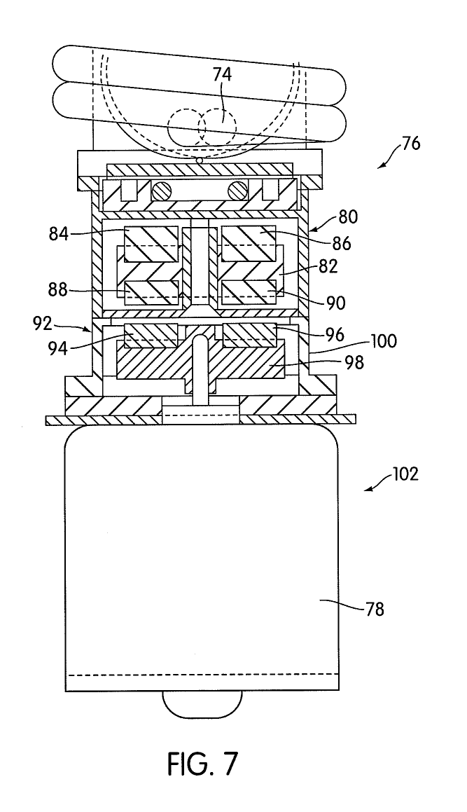

FIGS. 6 and 7, embodiments of an assembly for actuating a magnetic stirring device 74 are shown. In FIG. 6, one embodiment of the electromagnetic stirrer assembly includes four electromagnetic coils 70a, 70b, 70c, 70d wound on bobbins 72 at each of the reaction stations 16, 18, 20, 22, 24, 26. The number of electromagnetic coils at a given reaction station may vary. For example, a reaction block having forty-eight cells may share sixty-five coils.

The stirring reaction is created by energizing coils 70a, 70d with coil 70a being polarized for North and coil 70d being polarized for South. Next, coils 70a, 70d are switched off at the same time coils 70b, 70c are energized. Coil 70b is polarized for North, and coil 70c is polarized for South. Next, coils 70b, 70c are switched off at the same time coils 70a, 70d are switched on. This time coil 70a is polarized for South and coil 70d is polarized for North. Next, coils 70a, 70d are switched off, and coils 70b, 70c are energized. This time coil 70b is polarized for South and coil 70c is polarized for North. This process keeps repeating. The magnetic stirring device 74 (shown in FIG. 7) is magnetized with one end polarized for North and the other end polarized for South. Thus, the magnetic interaction of the magnetized stirring device 74 and the switching polarities of the electromagnetic coils 70a, 70b, 70c, 70d serve to actuate the magnetic stirring device 74 to stir the contents inside a reaction vessel.

An alternative embodiment of an electromagnetic stirrer assembly is shown in FIG. 7. Beneath each reaction station 16, 18, 20, 22, 24, 26 is located a respective multi-stage drive 76 designed to protect the drive motor 78 such as an electric drive motor 78 from the temperature extremes to which the reaction vessel is subjected. A first stage 80 nearest the bottom of the reaction vessel is hermetically or airtight sealed and either gas-filled or under a vacuum. A metal bar 82 formed of steel or other suitable metallic material is provided to rotate about a rotational axis within the sealed first stage 80. The metal bar 82 supports a first pair of cylindrical bar magnets or electromagnets 84, 86 of opposing polarity which is arranged on one side of the metal bar. The magnets 84, 86 are arranged with respect to the bar 82 such that their axes of rotation are parallel with the axis of rotation of the metal bar 82. The pair of magnets 84, 86 are arranged to either side of the axis of rotation of the metal bar 82 and spaced an equal distance apart from the axis of rotation. The pair of magnets 84, 86 are arranged to magnetically couple to the magnetic stirrer 74 provided inside the reaction vessel in order to stir the reactants inside the reaction vessel.

The bar 82 also supports a second pair of magnets or electromagnets 88, 90 which are similar to the first pair of magnets 84, 86 and similarly arranged, but which have a reverse polarity from the first pair of magnets 84, 86. The second pair of magnets 88, 90 are magnetically coupled to a second stage 92 of the multi-stage drive 76 which is outside of the hermetically sealed stage 80.

The metal bar 82 is driven magnetically by a magnetic coupling of the second pair of magnets 88, 90 with a third pair of magnets or electromagnets 94, 96 arranged in the second stage 92. The second stage 92 includes a second metal bar 98 supporting the third pair of magnets 94, 96 similar to the first and second pair of magnets 84, 86 and 88, 90, respectively, and similarly arranged. The metal bar 98 may be formed or steel or any other suitable metallic material. The third pair of magnets 94, 96 and the second metal bar 98 are disposed in an outer casing 100 made of a thermally resistant material which acts as a thermal shunt to the motor 78. The second metal bar 98 is driven by a motor 78 located in a third stage 102. The motor 78 drives the second metal bar 98 directly.

The operation of the motor 78 controls the rate at which the magnetic stirrer 74 stirs, i.e., the rate of rotation of the magnetic stirrer 74. The motor 78 is in communication with the controller 15 and provides stirring rate information to the controller 15. Thus, the stirring rate may be monitored and adjusted through the controller 15.

Having thus described the overall structure of the reaction assembly, the refrigeration system will now be described. FIGS. 8 and 9 show one example embodiment of a refrigeration circuit 104. The refrigeration system 104 shown is a single stage system having a single compressor capable of chilling the reaction block to −40° C.

The refrigeration system 104 connects to a reaction block such as reaction block 12 with two gas tubes with gas tight quick connect/quick disconnect fittings (11, 13 shown in FIG. 8), for example. In addition, there is a communications lead linking the refrigeration system 104 to the controller 15, or the communication can be made wirelessly. The refrigeration system 104 provides feedback refrigeration information to the controller and the controller acts to control the refrigeration system.

The refrigeration system 104 includes a compressor 106 which compresses the refrigerant in the system to raise its pressure and temperature, thereby turning the refrigerant into a high pressure, superheated gas. The refrigerant moves from the compressor 106 to a condenser 108. The condenser 108, which is air cooled by a fan, changes the refrigerant from a high temperature gas to a warm temperature liquid. From there, the refrigerant moves into a receiver 110, and through an oil separator filter/drier 114, and optionally through a sight glass 116. The sight glass 116 may be used to visually check a refrigerant level in the system 104.

Next, the refrigerant moves to a solenoid valve 118 which is arranged in communication with the controller 15. When the controller 15 operates to open the solenoid valve 118, the refrigerant moves through the solenoid valve 118 toward the metering devices or valves 58, 60, 62, 64, 66 and 68. The metering devices 58, 60, 62, 64, 66 and 68 are arranged in communication with the controller 15. An enlarged view of the metering valves 58, 60, 62, 64, 66 and 68 is shown in FIG. 9. As shown in FIG. 9, the refrigerant is fed to the metering valves from a common rail 120 and returned to the compressor via a low pressure common rail 122. The pressure is monitored by a pressure sensor 124 provided in communication with the low pressure common rail 122 and in communication with the controller 15. The pressure sensor 124 communicates pressure information to the controller 15 which in turn acts to control the variable speed compressor 106.

The metering devices 58, 60, 62, 64, 66 and 68 may be thermal expansions valves, for example, and in this example embodiment are six electronic thermal expansion valves. The valves 58, 60, 62, 64, 66 and 68 meter the proper amount of refrigerant into each of the evaporators 126, 128, 130, 132, 134, and 136 associated with a respective reaction station. Each electronic expansion valve 58, 60, 62, 64, 66 and 68 receives the high pressure refrigerant which it expands and changes it to a low pressure cold saturated gas. The saturated refrigerant gas enters the evaporator 126, 128, 130, 132, 134, and 136, which changes it to a cool dry gas, i.e., no liquid present.

The cool dry gas is then transferred by way of solenoid valves 142 and 144. As with solenoid valve 118, solenoid valves 142 and 144 are arranged in communication with the controller 15. The opening of the solenoid valves 142 and 144 moves the refrigerant either through an air cooled heat exchanger 138 through an oil accumulator tank 146 to the compressor 106 or directly through the oil accumulator tank 146 to the compressor 106, respectively, to be re-pressurized and recirculated through the refrigeration circuit 104.

Initially, solenoid valve 144 is closed and the controller acts to open solenoid valve 142 so that the returning refrigerant gas, which is at a very high temperature, is routed through solenoid valve 142 to the air cooled heat exchanger 138 which cools the heated gas. The returning gas is cooled in this manner to protect the compressor 106 from damage caused by excessive heat. Once the evaporators 126, 128, 130, 132, 134, and 136 have cooled sufficiently and the returning gas is cold enough, as measured by a thermistor 140, the controller 15 acts to close solenoid valve 142, and open solenoid valve 144, thereby routing the refrigerant gas through solenoid valve 144 directly to the compressor 106 through oil accumulator tank 138 for re-pressurization and recirculation.

When it is desired to heat the reaction stations, the controller 15 acts to prevent excessive pressures within the refrigeration system 104 by closing solenoid valve 118 and operating the compressor 106 to evacuate the refrigerant gas from the evaporators 126, 128, 130, 132, 134, and 136 and pipe work (i.e., “pump down” the system) and to pump the refrigerant gas into the reservoir 110. The evaporator combined pressure, as measured by pressure sensor 124 is fed to the control electronics or controller 15. This feedback of pressure information to the controller 15 controls the demand of the inverter driven compressor 106. When all the gas is evacuated, solenoid valves 142 and 144 are closed. Then, the reaction stations may be heated to a desired temperature.

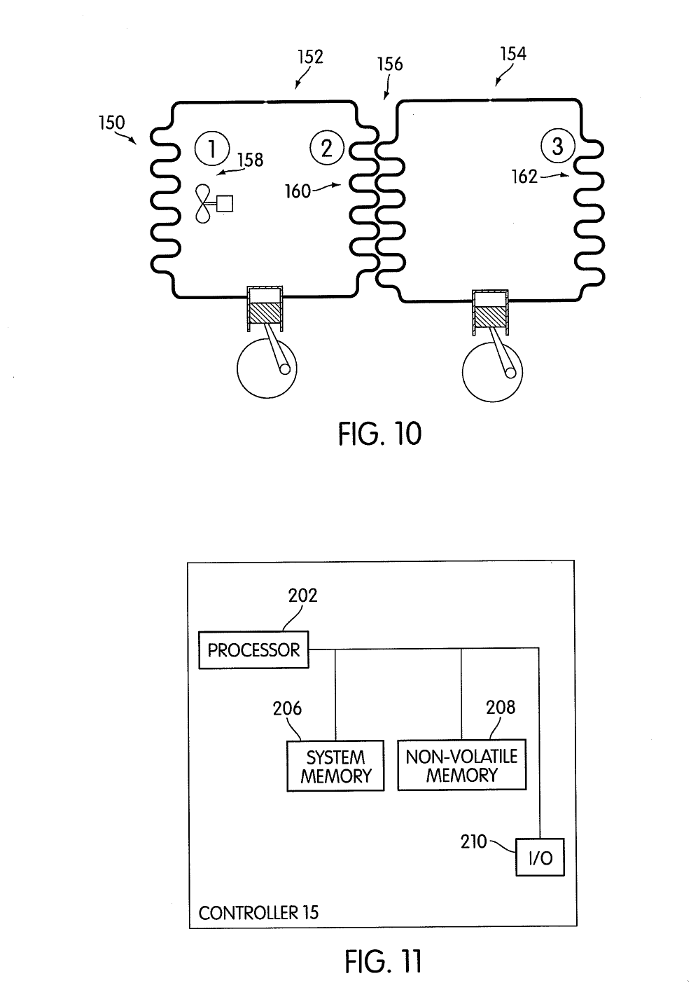

A portion of an example embodiment of a two-stage refrigeration system 150 is shown in FIG. 10. With two stages, the reaction assembly 10 can reach higher temperatures, cool down faster and have better condensing. The two stage refrigeration system 150 is a cascade system of two refrigeration circuits 152, 154 connected only by an intermediate cascade heat exchanger 156. The two refrigeration circuits 152, 154 include a high-temperature circuit 152 and a low-temperature circuit 154. The cascade refrigeration system 150 has two compressors instead of the one compressor associated with the single stage refrigeration circuit. The cascade refrigeration system 150 is capable of obtaining temperatures lower than the −40° C. possible with the single stage refrigeration circuit. With the cascade refrigeration system 150, it is possible to reach a temperature of around −80° C., for example.

As shown in FIG. 10, the high-temperature circuit 152 is cooled by an air condenser 158 at ambient temperature, and uses a cascade heat exchanger 160 as the system evaporator. The low-temperature circuit 154 produces the low-temperature cooling in the cold evaporator 162, and uses the cascade heat exchanger 160 as a condenser.

Thus, the intermediate cascade heat exchanger 160 thermally couples the two refrigerant circuits 152, 154 by functioning simultaneously as an evaporator and a condenser. The cascade heat exchanger 160 is exposed to temperature and pressure fluctuations. The evaporating side typically operates at −10 to −20° C., while the discharge gas from the low-temperature compressor may very well be 80° C. or higher. However, because the cascade refrigeration system 150 is composed of two separate refrigeration circuits 152, 154, different refrigerants may be selected for each of the refrigeration circuits 152, 154.

A refrigerant with a higher vapor pressure may be preferable in the low-temperature circuit, while a refrigerant with a lower vapor pressure may be preferable in the high-temperature circuit. The ability to select different refrigerants for the separate refrigeration circuits 152, 154 eliminates the problem associated with requiring one refrigerant to perform at both the highest and the lowest pressure levels.

In addition, oil distribution throughout the cascade refrigeration system 150 is more evenly distributed. Although refrigerant oil has a higher solubility in the refrigerant at higher temperatures, with the cascade refrigeration system, oil distribution in the low temperature circuit can be handled separately from oil distribution in the high temperature circuit. Thus, a risk of uneven oil distribution is reduced.

Thus, with the reaction assembly 10, a combination reaction block 12 and chiller 14 is provided in a compact footprint size that has the ability to switch with increased speed from a high temperature to a low temperature without having to change refrigerant fluids. Also, the reaction assembly 10 addresses global potential warming concerns (GPW). With the possible phasing out of current refrigerants, other potential refrigerants that might be considered in the future could include CO₂ or Helium, both of which have the potential for low temperature cooling and the gas refrigeration system of the present reaction assembly 10 is adapted to accommodate.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A reaction assembly configured to control a temperature of contents contained within a reaction vessel utilizing a refrigerant gas, comprising:
a plurality of reaction stations each defining a reaction chamber adapted to receive an associated reaction vessel and defining a gas conducting passageway for conducting the refrigerant gas through said reaction stations in temperature transmitting relation thereto;
a heating device thermally coupled to a respective one of said plurality of reaction stations and configured to heat the contents inside the reaction vessel at the respective one of said plurality of reaction stations such that the heating of the one respective reaction station is thermally independent from the heating of another one of said plurality of reaction stations; and
a metering device in fluid communication with the respective one of said reaction stations and configured to receive liquid refrigerant and to deliver an amount of refrigerant gas to the gas conducting passageway of the one respective reaction station to cool the contents inside the associated reaction vessel such that the amount of the refrigerant gas delivered to the gas conducting passageway of the one reaction station is independent of the amount of refrigerant gas delivered to the another one of said reaction stations.

2. The reaction assembly according to claim 1, wherein said metering device is an expansion valves configured to expand liquid refrigerant to gaseous refrigerant.

3. The reaction assembly according to claim 1, further comprising a controller, wherein said heating device and said metering device at the respective reaction station are in communication with said controller, and said controller acts to control said heating device and said metering device to adjust the heating and the cooling of the respective reaction station.

4. The reaction assembly according to claim 1, wherein said controller is in communication with said metering device and is configured to control the amount of the refrigerant gas delivered by said metering device to a respective one of said reaction stations, and wherein said controller acts to control said metering device separately from another said metering device provided at another respective one of said reaction stations.

5. The reaction assembly according to claim 3, wherein at each of said reaction stations the heating device comprises an infrared heater thermally coupled to said reaction station.

6. The reaction assembly according to claim 3, wherein at each of said reaction stations said associated heating device comprises a sleeve heater surrounding the periphery of said respective one of said reaction stations so that the reaction vessel in said respective reaction station is thermally coupled to said sleeve heater.

7. The reaction assembly according to claim 1, further comprising a moving device configured to be magnetically operated to stir the contents within the reaction vessel.

8. The reaction assembly according to claim 7, wherein said moving device comprises a magnetic stirrer located within the reaction vessel and a magnetic field generating motor, wherein said motor generates a magnetic field which magnetically couples and drives said stirrer to stir the contents within the reaction vessel.

9. The reaction assembly according to claim 8, wherein a rate at which said stirrer stirs is adjustable.

10. The reaction assembly according to claim 4, further comprising a temperature sensor coupled to said reaction assembly and configured to communicate temperature information to said controller.

11. The reaction assembly according to claim 4, further comprising a pressure sensor coupled to said reaction assembly and configured to communicate pressure information to said controller.

12. The reaction assembly according to claim 1, wherein said metering device is constructed and arranged in fluid communication with a single stage refrigeration circuit having one compressor.

13. The reaction assembly according to claim 1, wherein said metering device is constructed and arranged in fluid communication with a cascade refrigeration circuit including at least two compressors.

14. The reaction assembly according to claim 13, wherein said cascade refrigeration circuit comprises two separate refrigeration circuits configured to thermally couple to each other.

15. The reaction assembly according to claim 14, wherein said cascade refrigeration circuit further comprises a heat exchanger configured to thermally couple said two refrigerant circuits by acting simultaneously as an evaporator and a condenser.

16. A method for cooling contents contained inside a reaction vessel arranged at a respective reaction station within a reaction block, comprising:
introducing a refrigerant gas into a respective reaction station of a reaction block;
conducting the refrigerant gas through a gas conducting passageway defined within the respective reaction station in temperature transmitting relation thereto; and
cooling contents inside a reaction vessel contained at the respective reaction station within the reaction block with the refrigerant gas.

17. The method according to claim 16, wherein said cooling further comprises cooling the contents within a temperature range of about −40° C. to about −80° C.

18. The method according to claim 16, further comprising actuating a thermal expansion valve configured to introduce the refrigerant gas into the respective reaction station from an associated refrigerant circuit.

19. The method according to claim 16, wherein said cooling further comprises cooling with a single stage refrigeration circuit.

20. The method according to claim 16, wherein said cooling further comprises cooling with a cascaded stage refrigeration circuit.

21. The method according to claim 16, further comprising thermally coupling two refrigeration circuits with a heat exchanger configured to operate simultaneously as an evaporator in one of the circuits and as a condenser in the other of the circuits.

22. The method according to claim 16, further comprising providing reflux cooling to the top of the reaction vessel to condense reactant vapors of the contents inside the reaction vessel back into the reaction vessel.

23. A reaction block configured to utilize a refrigerant gas, comprising:
a plurality of reaction stations each defining a reaction chamber adapted to receive an associated reaction vessel and defining a gas conducting passageway for conducting the refrigerant gas through said reaction stations in temperature transmitting relation thereto; and
a metering means in fluid communication with a respective one of said reaction stations and configured to receive a liquid refrigerant and to deliver an amount of refrigerant gas to the gas conducting passageway of said one reaction station to cool the contents inside the associated reaction vessel such that the amount of the refrigerant gas delivered to the gas conducting passageway of said one reaction station is independent of the amount of refrigerant gas delivered to another one of said reaction stations.

24. The reaction block according to claim 23, further comprising a heating means thermally coupled to the respective one of said plurality of reaction stations and configured to heat the contents inside the reaction vessel at the respective one of said plurality of reaction stations such that the heating of the one respective reaction station is thermally independent from the heating of another one of said plurality of reaction stations.

25. The reaction block according to claim 23, wherein said metering means is an expansion valves configured to expand liquid refrigerant to gaseous refrigerant.

26. The reaction block according to claim 24, further comprising a controller, wherein said heating means and said metering means at the respective reaction station are in communication with said controller, and said controller acts to control said heating means and said metering means.

27. The reaction block according to claim 26, wherein said controller is configured to control the amount of the refrigerant gas delivered by said metering means to the respective one of said reaction stations, and wherein said controller acts to control said metering means separately from another said metering means provided at another respective one of said reaction stations.

28. The reaction block according to claim 23, further comprising a moving means configured to be magnetically operated to stir contents within the associated reaction vessel.

29. The reaction block according to claim 28, wherein said moving means comprises a magnetic stirring means located within the reaction vessel and a magnetic field generating motor, wherein said motor generates a magnetic field which magnetically couples and drives said magnetic stirring means to stir the contents within the associated reaction vessel.

30. The reaction block according to claim 29, wherein a rate at which said magnetic stirring means stirs is adjustable.

31. The reaction block according to claim 23, further comprising a temperature sensor coupled to said reaction block and configured to communicate temperature information to said controller.

32. The reaction block according to claim 23, further comprising a pressure sensor coupled to said reaction block and configured to communicate pressure information to the controller.

33. The reaction block according to claim 23, wherein said metering means is constructed and arranged in fluid communication with a refrigeration circuit.

34. The reaction block according to claim 33, wherein said refrigeration circuit is a cascade refrigeration circuit including two separate refrigeration circuits configured to thermally couple to each other through a shared heat exchanger configured to operate as an evaporator in one of the refrigeration circuits and as a condenser in the other one of the refrigeration circuits.
